(19) United States
(12) Patent Application Publication
(10) Pub. No.: US 2026/0079429 A1
(43) Pub. Date: Mar. 19, 2026

(54) IMAGE FORMING APPARATUS

(71) Applicant: CANON KABUSHIKI KAISHA, Tokyo (JP)

(72) Inventor: KENICHI HIROTA, Ibaraki (JP)

(21) Appl. No.: 19/318,611

(22) Filed: Sep. 4, 2025

(30) Foreign Application Priority Data
Sep. 17, 2024 (JP) 2024-160021

(51) Int. Cl. G03G 15/20; G03G 15/00

(52) U.S. Cl. CPC G03G 15/2028; G03G 15/657; G03G 15/703; G03G 2215/00413; G03G 2215/00514; G03G 2215/00548; G03G 2215/00949

(57) ABSTRACT

An image forming apparatus includes a fixing roller to fix an image by heating a sheet on which the image is transferred and to convey the sheet. In a case in which a first plain paper of which a sheet length in a sheet conveyance direction is equal to or more than a predetermined length is conveyed, the fixing roller conveys the first plain paper at a first speed. In a case in which a second plain paper of which the sheet length is less than the predetermined length is conveyed, the fixing roller conveys the second plain paper at a second speed less than the first speed. In a case in which an envelope of which the sheet length is less than the predetermined length is conveyed, the fixing roller conveys the second envelope at the first speed.

### BACKGROUND

### Field of the Technology

The present invention relates to an image forming apparatus which forms an image on a recording material.

### Description of the Related Art

Conventionally, in an image forming apparatus of an electrophotographic type or an inkjet type, a fixing device which fixes an image by heating or drying a sheet, which is a recording material, with a heated fixing roller is widely used. As the fixing device, a fixing device in which, in a case where conveyance defect such as the sheet sticks to and winds around a fixing rotatable member such as the fixing roller (sheet jam) occurs, operation of a driving system such as the fixing roller is emergently stopped and a user is notified of the conveyance defect is known (see Japanese Patent Application Laid-Open No. 2023-100078).

### SUMMARY

However, as a size of the fixing device gets increased, in the case in which the fixing roller is stopped emergently, there is a possibility that it takes time until the fixing roller completely stops due to inertial force so that an overrun occurs. If the overrun occurs when the fixing roller around which the sheet winds is stopped emergently, the winding sheet comes not to be detected by a sheet sensor upstream of the fixing roller in a conveyance direction, and it may be in a state in which the sheet which causes the sheet jam cannot be detected.

An object of the present disclosure is to provide an image forming apparatus capable of detecting a sheet which causes a sheet jam by winding around a fixing rotatable member.

An aspect of the present disclosure is an image reading apparatus comprising: a transfer portion configured to transfer an image to a sheet; a fixing portion including a fixing rotatable member configured to fix the image by heating the sheet on which the image is transferred by the transfer portion and to convey the sheet; and a control portion configured to control a conveyance speed of the fixing rotatable member, wherein in a case in which a first plain paper of which a sheet length in a sheet conveyance direction is equal to or more than a predetermined length is conveyed, the fixing rotatable member conveys the first plain paper at a first speed, wherein in a case in which a second plain paper of which the sheet length in the sheet conveyance direction is less than the predetermined length is conveyed, the fixing rotatable member conveys the second plain paper at a second speed less than the first speed, and wherein in a case in which a second envelope of which the sheet length in the sheet conveyance direction is less than the predetermined length is conveyed, the fixing rotatable member conveys the second envelope at the first speed.

Further features of the present invention will become apparent from the following description of exemplary embodiments with reference to the attached drawings. The following description of embodiments is described by way of example.

### BRIEF DESCRIPTION OF THE DRAWINGS

FIG. 1 is a cross-sectional view illustrating an image forming apparatus according to an Embodiment.

FIG. 2 is a block diagram illustrating a control system of the image forming apparatus according to the Embodiment.

FIG. 3 includes side views illustrating a double feeding sensor according to the Embodiment, and part (a) is an ultra sonic sensor and part (b) is a thickness detecting sensor as a Modified Example.

FIG. 4 is a flowchart showing a process procedure of a double feeding detection in the image forming apparatus according to the Embodiment.

FIG. 5 is a cross-sectional view illustrating a state in which a sheet has wound around a fixing roller in the image forming apparatus according to the Embodiment.

FIG. 6 is a flowchart showing a process procedure of a winding detection in the image forming apparatus according to the Embodiment.

FIG. 7 is a flowchart showing a process procedure for adjusting a process speed in the image forming apparatus according to the Embodiment.

FIG. 8 is an explanatory view illustrating a sheet library displayed on the image forming apparatus according to the Embodiment.

FIG. 9 is a time chart illustrating a process procedure for forming images with switching between an envelope and a plain paper in the image forming apparatus according to the Embodiment.

### DESCRIPTION OF THE EMBODIMENTS

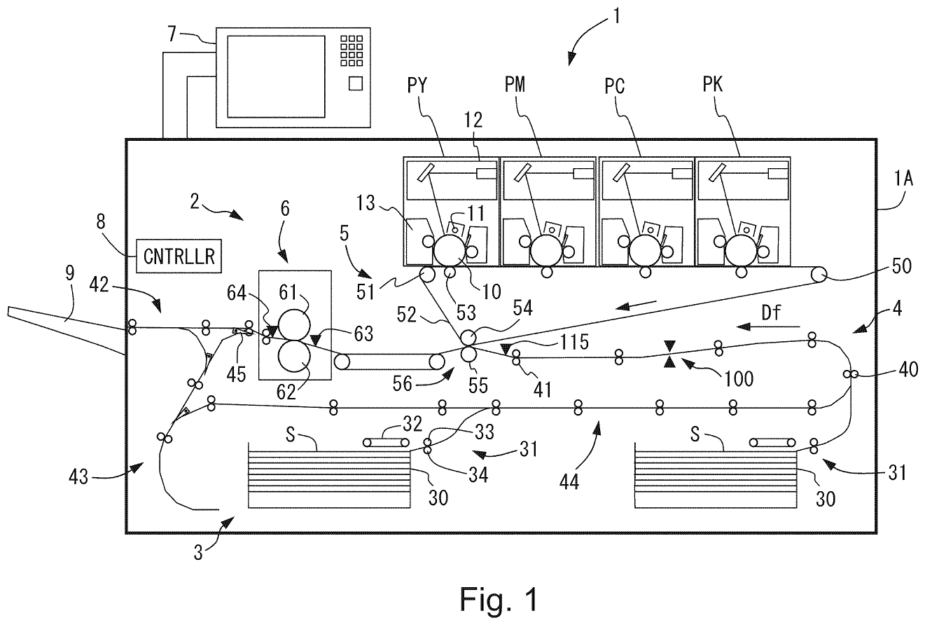

Hereinafter, the present Embodiment will be described using the drawings. First, an outline configuration of an image forming apparatus 1 according to the present Embodiment will be described using FIG. 1. FIG. 1 is a cross-sectional view illustrating the outline configuration of the image forming apparatus 1 according to the present Embodiment as viewed from a front side thereof. The image forming apparatus 1 is a laser beam printer of a tandem type and an intermediary transfer type using an electrophotographic process. The image forming apparatus 1 can form and output an image of a full-color or a single-color, which corresponds to printing image data output from an unshown host device which is connected to a control portion 8, on a sheet S, which is a recording medium. Incidentally, in the present Embodiment, a case in which the image forming apparatus is applied to the laser beam printer of the electrophotographic type is described, however, it is not limited thereto. For example, the image forming apparatus may be applied to a general apparatus which executes an image fixing with a heat drying type such as an inkjet printer and a dye sublimation printer.

### [Image Forming Apparatus]

The image forming apparatus 1 includes a main assembly 1A, an image forming portion 2 which forms the image on the sheet S, a feeding unit 3 which is an example of a feeding portion which feeds the sheet S, and a conveyance unit 4 which conveys the sheet S. To an upper portion of the image forming apparatus 1, an operating portion 7 which receives operation from a user is provided. For the operating portion 7, a touch panel type which serves a display function and an input function is employed. The operating portion 7 is connected to the control portion 8, and receives various types of information on a sheet the user uses for a printing (size information, basis weight information, surface quality information, etc.) and various types of operations the user performs such as an instruction for a print execution or an interruption thereof.

### [Image Forming Portion]

The image forming portion 2 forms the image on the sheet S which is fed by the feeding unit 3 and conveyed by the conveyance unit 4. The image forming portion 2 includes four process cartridges PY, PM, PC and PK, which form toner images of four colors of yellow (Y), magenta (M), cyan (C) and black (K), respectively. The four process cartridges PY, PM, PC and PK have the same configuration, except that the colors of the forming images are different. Therefore, only a configuration and an image forming process of the process cartridge PY will be described, and description for the process cartridges PM, PC and PK will be omitted. In addition, the image forming portion 2 includes an intermediary transfer portion 5 disposed below the process cartridges PY, PM, PC and PK, and a fixing portion 6.

The process cartridge PY includes a photosensitive drum 10 which is an electrophotographic photosensitive member of a drum shape, a primary charger 11, an exposure portion 12 and a developing unit 13. The photosensitive drum 10 is rotatably supported by the image forming apparatus 1, and is rotationally driven by an unshown driving means. The primary charger 11 charges the photosensitive drum 10. The exposure portion 12 accommodates a laser light source, which emits a laser light, and various types of optical members for performing deflection and scanning of the laser light by guiding the laser light emitted from the laser light source to the photosensitive drum 10. The exposure portion 12 irradiates a surface of the charged photosensitive drum 10 with the laser light based on the image information, and forms an electrostatic latent image. The developing unit 13 causes toner of the colors different from each other for each process cartridge PY, PM, PC and PK (yellow, magenta, cyan and black) to be adhered to the surface of the photosensitive drum 10, respectively. The developing unit 13 forms the toner image on the surface of the photosensitive drum 10 by developing the electrostatic latent image by causing the toner to be adhered to the electrostatic latent image on the surface of the photosensitive drum 10. To the developing unit 13, the toner is supplied from an unshown toner cartridge.

The intermediary transfer portion 5 is provided with an intermediary transfer belt 52 which is wound around a driving roller 50 and a tension roller 51. Inside the intermediary transfer belt 52, a primary transfer roller 53, which is in contact with the intermediary transfer belt 52 at a position opposing to the photosensitive drum 10, is provided. The intermediary transfer belt 52 is rotated in a direction of an arrow by the driving roller 50, which is driven by an unshown driving portion. The toner image developed on the photosensitive drum 10 is primarily transferred onto the intermediary transfer belt 52, to which a voltage of an opposite polarity to the toner image is applied. Upon color image formation, each color is sequentially formed onto the intermediary transfer belt 52 from the process cartridges PY, PM, PC and PK, and as a result, a full-color visible image is formed on the intermediary transfer belt 52.

The intermediary transfer portion 5 includes a secondary transfer inner roller 54, which is disposed in an inner peripheral portion of the intermediary transfer belt 52, and a secondary transfer outer roller 55, which is disposed opposite to the secondary transfer inner roller 54 across the intermediary transfer belt 52. The secondary transfer outer roller 55 forms a secondary transfer portion 56 between the intermediary transfer belt 52 and itself, and in the secondary transfer portion 56, the color image formed on the intermediary transfer belt 52 is secondarily transferred to the sheet S. In other words, by the secondary transfer outer roller 55 bringing the sheet S into press contact with the intermediary transfer belt 52, and at the same time, by applying a bias of the opposite polarity to the toner to the secondary transfer outer roller 55, the color image is secondarily transferred to the sheet S. The secondary transfer portion 56 is an example of a transfer portion, is disposed downstream of the feeding unit 3 and upstream of the fixing unit 6 in a sheet conveyance direction Df, and transfers (secondarily transfers) the image to the sheet S fed from the feeding unit 3.

### [Fixing Portion]

The fixing portion 6 fixes the toner image transferred to the sheet S with heat and pressure. The fixing portion 6 includes a fixing roller 61 for applying heat to the sheet S and a pressing roller 62 for bringing the sheet S into press contact with the fixing roller 61. The fixing roller 61 and the pressing roller 62 are both hollow rollers, and fix the toner to the sheet S by heating and causing the toner transferred to the sheet S to be melted with the heater incorporated in the fixing roller 61. In other words, the fixing roller 61 is an example of a fixing rotatable member, is disposed downstream of the feeding unit 3 in the conveyance direction of the sheet S, heats and fixes the image to the sheet S, and conveys the sheet S. Incidentally, in the present Embodiment, the fixing roller 61 is adopted as the fixing rotatable member, however, it is not limited thereto but, for example, a fixing belt or a fixing film may be adopted.

The fixing portion 6 includes a pre-fixing sensor 63, which is disposed upstream of a fixing nip portion formed by the fixing roller 61 and the pressing roller 62 in the conveyance direction, and a post-fixing sensor 64, which is disposed downstream of the fixing nip portion in the conveyance direction. The pre-fixing sensor 63 is an example of a first detecting portion, is disposed upstream of the fixing roller 61 in the sheet conveyance direction Df, and detects the sheet S conveyed to the fixing roller 61. The post-fixing sensor 64 is an example of a second detecting portion, is disposed downstream of the fixing roller 61 in the sheet conveyance direction Df, and detects the sheet S conveyed from the fixing roller 61.

### [Feeding Unit]

The feeding unit 3 includes a sheet cassette 30 and a feeding mechanism 31 which feeds the sheet S from the sheet cassette 30 to the conveyance unit 4. In the present Embodiment, a plurality of the sheet cassettes 30 are provided, and are capable of accommodating different sizes and types of the sheet S. The feeding mechanism 31 includes a pick up portion 32 and a separating roller pair constituted by a feed roller 33 and a retard roller 34 for separating the sheet S fed out by the pick up portion 32.

### [Conveyance Unit]

The conveyance unit 4 includes a plurality of conveyance roller pairs 40 which convey the sheet S, a registration roller pair 41 and a double feeding sensor 100. The sheet S separated one by one by the separating roller pair is conveyed to the registration roller pair 41 by the plurality of conveyance roller pairs 40. The registration roller pair 41 is disposed downstream of the feeding unit 3 and upstream of the secondary transfer portion 56 in the sheet conveyance direction Df, and the sheet S is abutted thereto in a state in which the registration roller pair 41 is stopped, and thereafter, the registration roller pair 41 is rotated to convey the sheet S. The double feeding sensor 100 is disposed upstream of the registration roller pair 41 in the sheet conveyance direction Df. The double feeding sensor 100 will be described below.

The conveyance unit 4 includes a discharging portion 42, a reversing portion 43 and a re-conveyance portion 44. The discharging portion 42 discharges the sheet S conveyed from the fixing portion 6 to a discharge tray 9 disposed outside the apparatus. The reversing portion 43 reverses a front and a back of the sheet S conveyed from the fixing portion 6. The re-conveyance portion 44 conveys the sheet S reversed by the reversing portion 43 again to the image forming portion 2. The sheet S conveyed from the fixing portion 6 is switched to be conveyed to the discharging portion 42 or conveyed to the reversing portion 43 by a switching portion 45 which switches a conveyance path of the sheet S.

### [Control System]

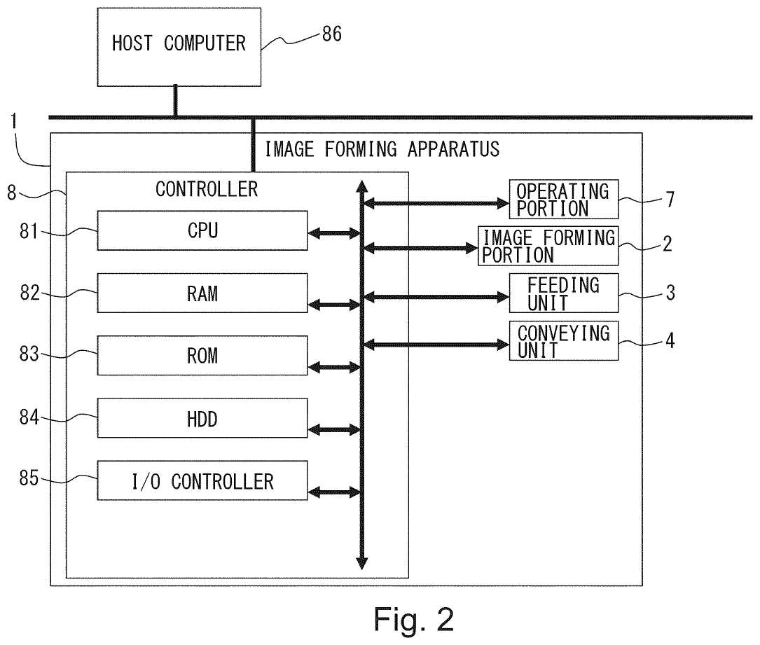

Next, the control portion 8 and a control system of the image forming apparatus 1 will be described using FIG. 2. The control portion 8 includes a CPU 81 (Central Processing Unit), a RAM 82, a ROM 83, an HDD 84 and an I/O control portion 85. The CPU 81 realizes various types of processes performed by the image forming apparatus 1 by executing a predetermined control program, etc. The RAM 82, the ROM 83 and the HDD 84 store various types of programs and various types of data in a predetermined storage area, respectively. The I/O control portion 85 performs sending and receiving of information with an external device. In the present Embodiment, the image forming apparatus 1 is connected to a host computer 86, and performs sending and receiving of various types of information such as a sheet information to be printed and an error information between the host computer 86 and itself.

### [Image Forming Operation]

Next, an image forming operation of the image forming apparatus 1 will be described. First, when the image forming apparatus 1 receives an image data of an original to be printed, the image information is, after subjected to image processing, converted to an electrical signal, and transmitted to the exposure portion 12 of the image forming portion 2. In the image forming portion 2, by the laser, the surface of the photosensitive drum 10, of which the surface is uniformly charged to a predetermined polarity and potential by the primary charger 11, is sequentially exposed. By this, on the photosensitive drums 10 in each of the process cartridges PY, PM, PC and PK, the electrostatic latent images of yellow, magenta, cyan and black are sequentially formed, respectively. Thereafter, the electrostatic latent image is developed and visualized by the toner of each color, and by a primary transfer bias applied to the primary transfer roller 53, the toner image of each color on each photosensitive drum 10 is sequentially superimposed on and transferred to the intermediary transfer belt 52. By this, the toner images is formed on the intermediary transfer belt 52.

In parallel with the toner image forming operation, the sheet S is fed one by one in the feeding unit 3. The sheet S fed from the feeding unit 3 is conveyed to the registration roller pair 41. By the sheet S being abutted to the stopped registration roller pair 41, an oblique movement thereof is corrected. The registration roller pair 41 conveys the sheet S to the secondary transfer portion 56 in synchronization with a timing when the toner image on the intermediary transfer belt 52 is transferred to the sheet S. In the secondary transfer portion 56, by a secondary transfer bias applied to a secondary transfer outer roller 55, the toner images are collectively transferred onto the sheet S.

The sheet S, to which the toner images have been transferred, is conveyed to the fixing portion 6, and in the fixing nip portion formed by the fixing roller 61 and the pressing roller 62, the toner of each color is melted and mixed in color by being subjected to heat and pressure, and fixed to the sheet S as a color image. The sheet S, to which the image has been fixed, is either discharged to the discharge tray 9 by the discharging portion 42, or in a case of a double-side printing, is passed through the reversing portion 43 and the re-conveyance portion 44, and a printing for a back surface is performed thereto.

### [Operation of the Double Feeding Sensor]

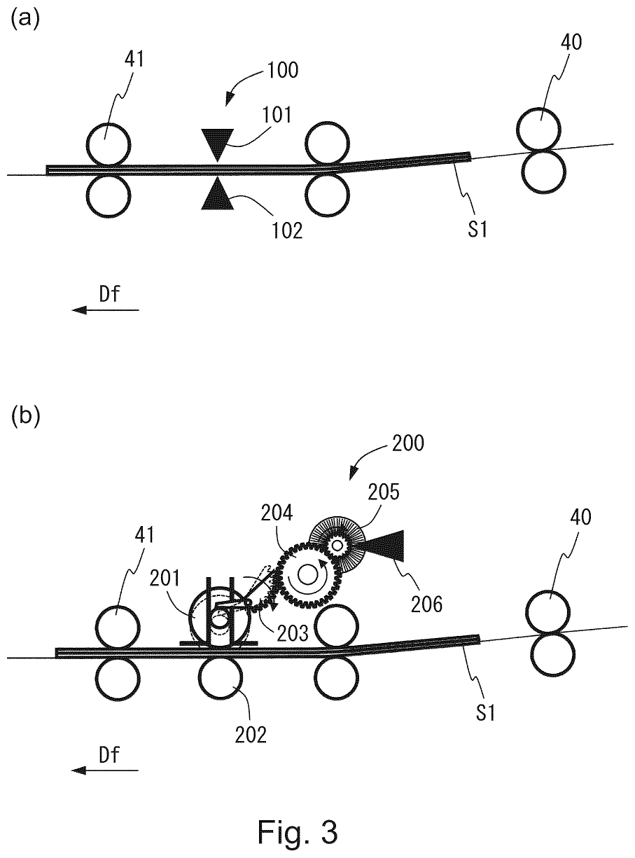

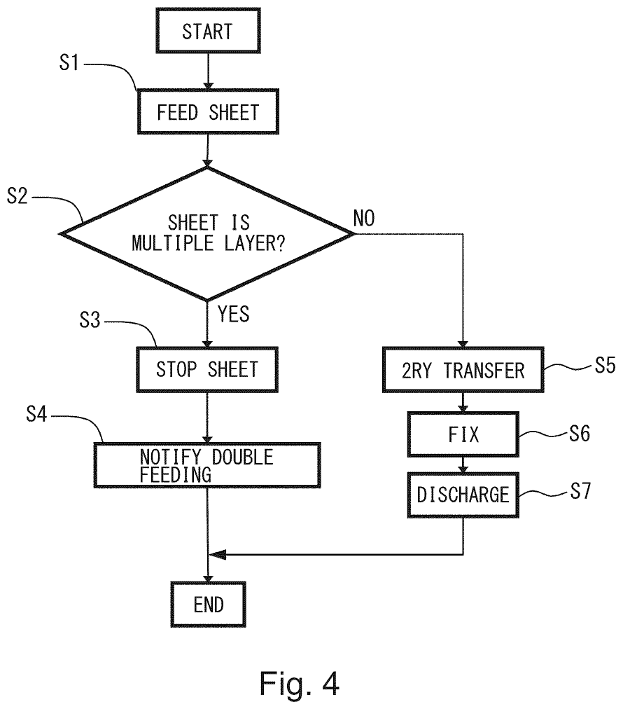

Next, an operation of the double feeding sensor 100 will be described using part (a) and part (b) of FIG. 3 and FIG. 4. The double feeding sensor 100 is a sensor which detects, for example, a state in which the sheets S are conveyed in a state in which a plurality of the sheets S are accidentally overlapped. The control portion 8 receives a detection result from the double feeding sensor 100, stops the image forming operation according to the detection result, and prevents a blank paper from being mixed into a product.

In part (a) and part (b) of FIG. 3, representative double feeding detection types are illustrated. Part (a) of FIG. 3 is a schematic view of the double feeding sensor 100 of an ultrasonic wave type. This double feeding sensor 100 is an ultra sonic sensor, and includes a transmitting element 101, which is an example of a transmitting portion which transmits an ultrasonic wave, and a receiving element 102, which is an example of a receiving portion which receives the ultrasonic wave transmitted from the transmitting element 101. In this double feeding sensor 100, whether the sheet S has a single layer or a multiple layer is detected according to a change in an amplitude and a change in a wavelength upon the receiving element 102 receiving an output wave from the transmitting element 101. For example, as shown in part (a) of FIG. 3, in a case in which a sheet S1 is an envelope, it is determined that the sheet S1 has the multiple layer.

Part (b) of FIG. 3 is a schematic view of a double feeding sensor 200 of a type which detects a thickness of the sheet S. When the sheet S fed from the feeding unit 3 is nipped by a pinch roller 201 and an opposing roller 202, a rotation shaft of the pinch roller 201 is moved in a vertical direction just by the thickness of the sheet S. This moved amount in the vertical direction is converted to a moved amount in a rotational direction and amplified at the same time by an arm gear 203 and an idler gear 204, and transmitted to an encoder wheel 205. By counting a rotated amount of the encoder wheel 205 with a sensor 206, the thickness of the sheet S is detected with high accuracy. In this detection type, in a case in which it is detected that the thickness of the sheet S is abnormally thick relative to a thickness set by the operating portion 7, it is determined that it is the double feeding (multiple layer).

Next, a process procedure for detecting the double feeding using the double feeding sensor 100 will be described using a flowchart shown in FIG. 4. When the image forming job is executed, the sheet S is fed by the feeding unit 3 (S1), and is conveyed by the conveyance unit 4. The control portion 8 determines whether or not the detection result by the double feeding sensor 100 is the multiple layer (S2). If the control portion 8 determines that the detection result by the double feeding sensor 100 is the multiple layer (S2; YES), then immediately stops the conveyance of the sheet S (S3). The control portion 8 stops the image forming operation, and through the operating portion 7, for example, notifies a user to prompt a jam clearance to continue the printing (S4). By this, mixing of a blank paper into the product is prevented. On the other hand, if the control portion 8 determines that the detection result by the double feeding sensor 100 is not the multiple layer in S2 (S2; NO), then as a normal process procedure, the secondary transfer (S5), the fixing (S6) and the discharging (S7) are executed. Incidentally, in the case of the double-side printing, instead of the discharging, the reversing and the re-conveyance are executed, and the printing for the back surface of the sheet S is executed.

### [Winding Around the Fixing Roller]

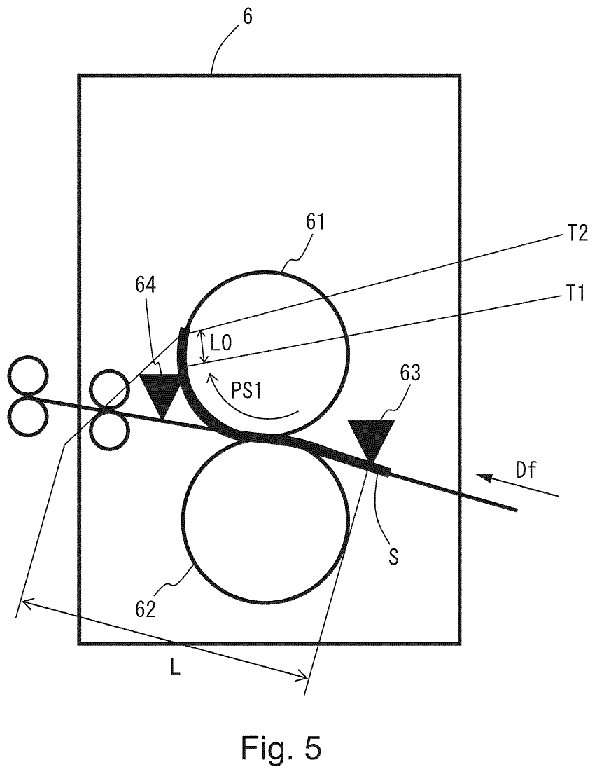

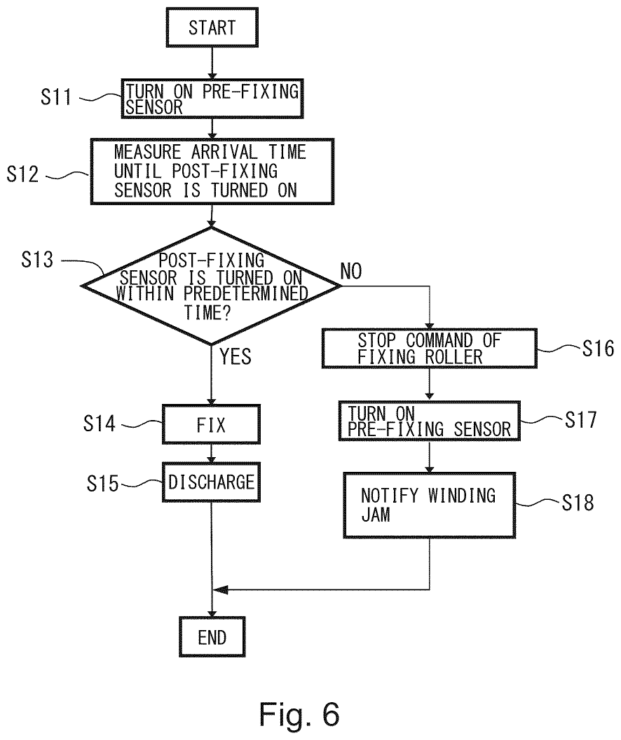

FIG. 5 illustrates a state in which a leading end of the sheet S sticks to the fixing roller 61 and a trailing end of the sheet S is being detected by the pre-fixing sensor 63 after the fixing roller 61 is emergently stopped. Using FIG. 6, a process procedure in a case in which the sheet S winds around the fixing roller 61 in the fixing portion 6 will be described.

The control portion 8 conveys the sheet S, to which the toner images have been transferred, to the fixing portion 6, and if the leading end thereof is detected by the pre-fixing sensor 63 (S11), then measures a time until the leading end of the sheet S reaches the post-fixing sensor 64 (S12). The control portion 8 determines whether or not the leading end of the sheet S can be detected by the post-fixing sensor 64 within a predetermined time (S13). If the control portion 8 determines that the leading end of the sheet S is detected by the post-fixing sensor 64 within the predetermined time (S13; YES), then as the normal process procedure, executes the fixing (S14) and the discharging (S15). Incidentally, in the case of the double-side printing, instead of the discharging, the reversing and the re-conveyance are executed, and the printing for the back surface is executed.

On the other hand, if the control portion 8 determines that the leading end of the sheet S is not detected by the post-fixing sensor 64 within the predetermined time (S13; NO), then executes the emergency stop of the fixing roller 61 at a time when the leading end of the sheet S is positioned at a timing T1 (see FIG. 5) (S14). In other words, the control portion 8 transmits a stop instruction to a driving portion which drives the fixing roller 61 (S16). In other words, if the sheet S conveyed from the fixing roller 61 is not detected by the post-fixing sensor 64 after a lapse of the set time, the control portion 8 executes the stop process which stops the rotation of the fixing roller 61.

After the fixing roller 61 has been stopped, the pre-fixing sensor 63 is in an ON state by the trailing end of the sheet S (S17). The control portion 8 then notifies through the operating portion 7, for example, of an occurrence of a winding jam (S18). A user looks at a processing guide screen notified on the operating portion 7, and can carry out the jam clearance reliably while visually recognizing the sheet S.

Here, the control portion 8 sends the stop instruction to the driving portion of the fixing roller 61 in S16, however, the fixing roller 61 cannot be stopped immediately due to an inertial force, so that actually is rotated until a time when the leading end of the sheet S is positioned at a timing T2. Therefore, there is a time lag from when the stop instruction is sent until when the fixing roller 61 stops. As shown in FIG. 5, an idle run distance L0 from when the stop instruction is sent until when the fixing roller 61 completely stops becomes larger as a rotation speed of the fixing roller 61 is faster. In the present Embodiment, the rotation speed of the fixing roller 61 corresponds to a process speed, so that the idle run distance L0 becomes larger as the process speed is faster. Therefore, in order to make the pre-fixing sensor 63 be capable of detecting the trailing end of the sheet S reliably even with a minimum sheet size (sheet length) Lmin for a specification of the image forming apparatus 1, a path length L from the pre-fixing sensor 63 to a leading end position after the idle run needs to satisfy a relationship of a mathematical expression (1).

$$L \leq Lmin - L 0 \qquad ( 1 )$$

In this manner, since the idle run distance L0 is determined by a process speed PS, if a length of the sheet S is less than a predetermined length, then it is necessary to set the process speed PS slower to shorten the idle run distance L0, and this is defined as a first process speed of low speed PS1. In a case of the case shown in FIG. 5, from a viewpoint of necessity to perform the winding detection control for a plain paper, the process speed is set to the first process speed PS1.

### [Setting for the Process Speed]

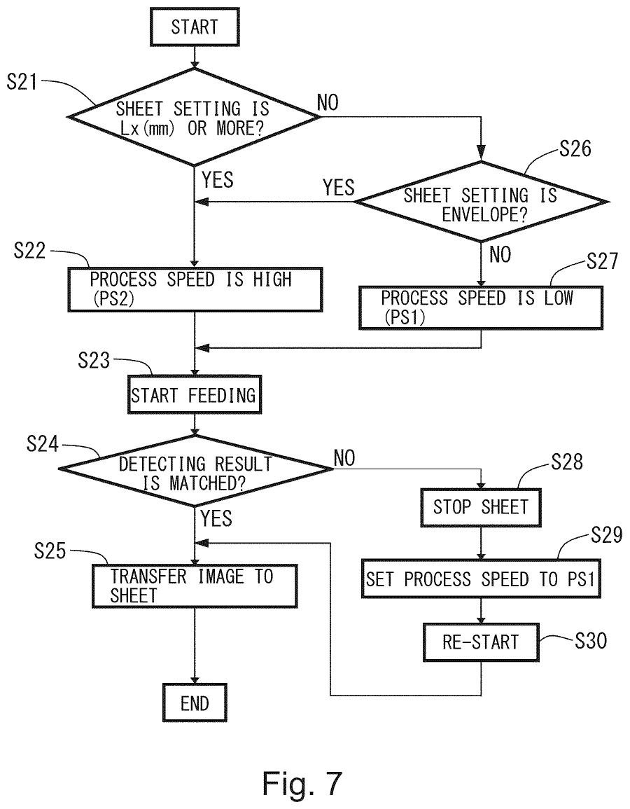

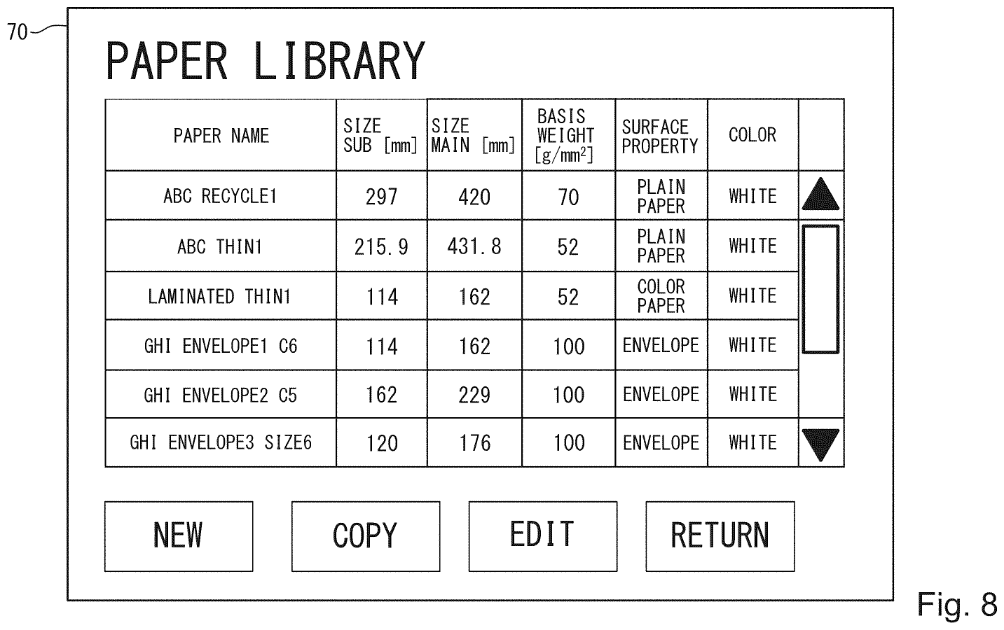

Next, a setting for the process speed in the present Embodiment will be described using FIG. 7 through FIG. 9. FIG. 7 is a flowchart showing a process procedure for setting the process speed in the present Embodiment. FIG. 8 illustrates a display screen 70 of the operating portion 7, and here shows a case in which a sheet library for setting a type of the sheet S accommodated in the sheet cassette 30 is displayed. Here, it is possible to set whether it is an envelope or a plain paper, etc. along with a size thereof. The plain paper is, for example, a sheet with a basis weight of 64 through 105 g/m². In addition, the operating portion 7, which includes the display screen 70, is an example of an input portion, through which it is possible to input layer information as to whether the sheet to be fed is a single layer type with only one sheet or a multiple layer type (envelope) with two or more sheets being overlapped. In addition, here, the double feeding sensor 100 is an example of a layer detecting sensor, which detects the layer information as to whether the conveyed sheet is the single layer type or the multiple layer type. Incidentally, the process speed PS is, for example, a peripheral speed of the fixing roller 61.

The control portion 8 determines whether or not a length of the sheet set on the display screen 70 is equal to or more than a predetermined length Lx (mm) (S21). When the control portion 8 determines that the length of the sheet is equal to or more than the predetermined length Lx (mm) (S21; YES), even if the idle run distance of the fixing roller 61 becomes large, the trailing end of the sheet S can be detected by the pre-fixing sensor 63. Therefore, the control portion 8 sets the process speed PS to a second process speed of high speed PS2 (S22). By this, it becomes possible to maintain productivity high. As the predetermined length Lx (mm), for example, B5 size (182 mm) can be applied.

If the control portion 8 determines that the length of the sheet S set on the display screen 70 is less than the predetermined length Lx (mm) (S21; NO), then determines whether or not the sheet S set on the display screen 70 is an envelope (S26). If the control portion 8 determines that the sheet S set on the display screen 70 is not an envelope (S26; NO), then sets the process speed PS to the first process speed of low speed PS1 (S27). By this, even if the fixing roller 61 does the idle run after the emergency stop, it becomes possible to allow the trailing end of the sheet S to be detected by the pre-fixing sensor 63. When the control portion 8 determines that the sheet S set on the display screen 70 is an envelope (S26; YES), an envelope is more rigid and less flexed than a plain paper. Therefore, even when a length of the envelope is short, it is less likely to cause the winding jam around the fixing roller 61, so that the control portion 8 sets the process speed PS to the second process speed of high speed PS2 (S22).

After determining the process speed, the control portion 8 starts the feeding of the sheet S (S23). The control portion 8 detects whether or not the sheet S is the single layer type with the double feeding sensor 100, and determines whether or not the detection result corresponds to the type of the sheet S set on the display screen 70 (S24). In other words, if the sheet S set on the display screen 70 is an envelope and the detection result by the double feeding sensor 100 is a multiple layer, or if the sheet S set on the display screen 70 is a plain paper and the detection result by the double feeding sensor 100 is a single layer, then the control portion 8 determines that the detection result corresponds. If the sheet S set on the display screen 70 is an envelope and the detection result by the double feeding sensor 100 is a single layer, or if the sheet S set on the display screen 70 is a plain paper and the detection result by the double feeding sensor 100 is a multiple layer, then the control portion 8 determines that the detection result does not correspond.

If the control portion 8 determines that the detection result corresponds (S24; YES), then transfers the image to the sheet S (S25), and thereafter executes the processes in the same manner as in the flowchart shown in FIG. 6. If the control portion 8 determines that the detection result does not correspond (S24; NO), then stops the sheet (S28). Since the sheet S may be a plain paper of which the length is less than the predetermined length Lx (mm), the control portion 8 sets the process speed PS to the first process speed of low speed PS1 (S29), and restarts the conveyance of the sheet S (S30).

In other words, for a plain paper and a second sheet of which a sheet length is shorter than Lx (mm), if the layer information acquired through the display screen 70 is the single layer type and the layer information detected by the double feeding sensor 100 is the single layer type, then the control portion 8 executes a first mode. The first mode is a mode, in a case in which a sheet is fed from the feeding unit 3 at a feeding speed Sf, in which a conveyance speed is set to the first process speed of low speed PS1 and the sheet is conveyed. On the other hand, for an envelope and the second sheet of which the sheet length is shorter than Lx (mm), if the layer information acquired through the display screen 70 is the multiple layer type and the layer information detected by the double feeding sensor 100 is the multiple layer type, then the control portion 8 executes a second mode. The second mode is a mode, in the case in which a sheet is fed from the feeding unit 3 at the feeding speed Sf, in which a conveyance speed at the fixing roller 61 is set to the second process speed of high speed PS2 and the sheet is conveyed. The control portion 8 is capable of executing the first mode and the second mode for the second sheet of which the sheet length is shorter than Lx (mm).

In this manner, in the present Embodiment, for a plain paper (first sheet) of which a sheet length is equal to or more than Lx (mm) (first length), if the sheet is fed at the feeding speed Sf, the control portion 8 sets the conveyance speed at the fixing roller 61 to the second process speed of high speed PS2 (first speed) and conveys the sheet. In addition, for a plain paper (second sheet) of which a sheet length is shorter than Lx (mm) (second length), if the sheet is fed at the feeding speed Sf, the control portion 8 set the conveyance speed at the fixing roller 61 to the first process speed PS1 of low speed (second speed) and conveys the sheet. In this case, the second speed is slower than the first speed, and is a speed with which the second sheet can be stopped at a position where the second sheet is detected by the pre-fixing sensor 63 when the stop process is executed.

In addition, in the present Embodiment, for the first sheet, if the first sheet is fed at the feeding speed Sf, the control portion 8 sets the conveyance speed at the secondary transfer portion 56 and the fixing roller 61 to the second process speed PS2 of high speed and conveys the first sheet. In addition, for the first sheet, if the first sheet is conveyed from the feeding unit 3 to the registration roller pair 41 with the feeding speed Sf as a maximum speed, the control portion 8 sets the conveyance speed to the second process speed PS of high speed and conveys the first sheet.

On the other hand, for the second sheet, if the second sheet is fed at the feeding speed Sf, the control portion 8 sets the conveyance speed at the secondary transfer portion 56 and the fixing roller 61 to the first process speed PS1 of low speed and conveys the second sheet. In addition, for the second sheet, if the second sheet is conveyed from the feeding unit 3 to the registration roller pair 41 with the feeding speed Sf as a maximum speed, the control portion 8 sets the conveyance speed to the first process speed PS of low speed and conveys the second sheet.

In the present Embodiment, a thick paper is a sheet of which a basis weight is 106 through 163 g/m², for example. Incidentally, in a case in which a thick paper of which the basis weight is particularly large (for example, the basis weight is 257 through 500 g/m²) is conveyed, in order to ensure fixing performance, it may be configured that the conveyance speed at the fixing roller 61 is set to the first process speed PS1 of low speed and the thick paper is conveyed.

[A Case in which an Unintentional Sheet is Mixed In]

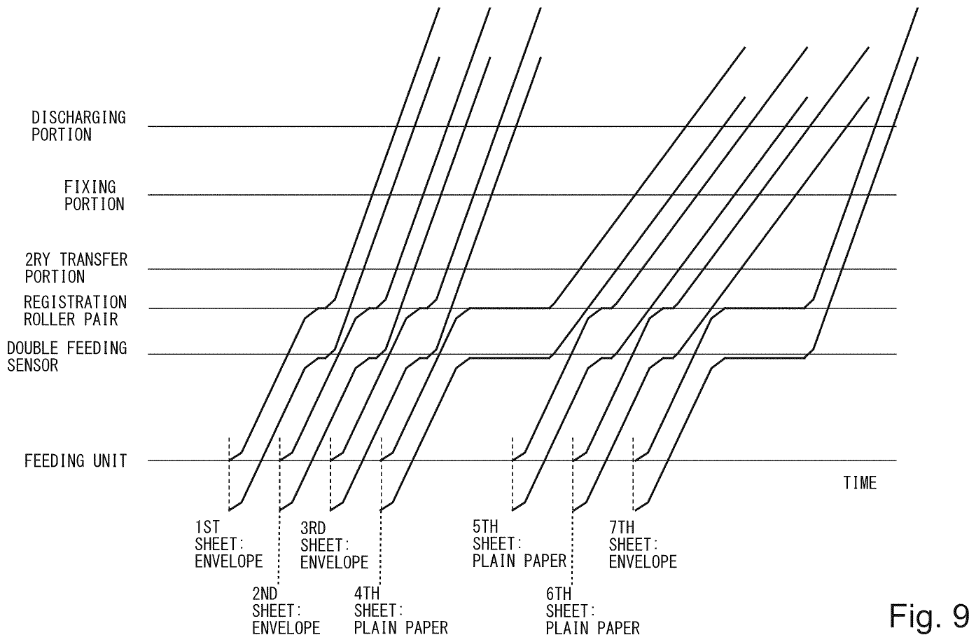

FIG. 9 is a time chart upon the images being formed continuously to seven envelopes. Here, assuming a case in which after the envelopes are fed for a first sheet through a third sheet, for a fourth sheet through a sixth sheet, three sheets of the plain papers are mixed in between the envelopes in the sheet cassette 30, and thereafter, the envelope is fed again for a seventh sheet.

For the first sheet through the third sheet, the detecting results by the double feeding sensor 100 correspond to the envelopes set through the display screen 70, and the image formation can be continued with keeping the second process speed PS2 of high speed, so that high productivity can be maintained. In the present Embodiment, for the envelope, it is set to the second process speed PS2 of high speed. The second process speed PS2 is set faster than the feeding speed Sf, which is the maximum speed at which the sheet is fed from the feeding unit 3. On the other hand, for the fourth sheet through the sixth sheet, due to the plain papers mixed in the sheet cassette 30, the detecting results by the double feeding sensor 100 become the single layer. Therefore, the control portion 8 pauses the conveyance of the sheet S at the registration roller pair 41 (S28), and switches to the first process speed PS1 of low speed (S29) during that time. In the present Embodiment, for the plain paper, it is set to the first process speed of lower speed PS1. The first process speed PS1 is set slower than the feeding speed Sf, which is the maximum speed at which the sheet is fed from the feeding unit 3.

As for passing through the fixing portion 6 at the first process speed PS1, even if the length of the sheet S is less than Lx (mm), since it is possible for the pre-fixing sensor 63 to detect the sheet S upon winding around the fixing roller 61, the image forming operation can be continued. Alternatively, when the sheet S winds around the fixing roller 61, in order to avoid risk of the mixing of the blank paper in a product, it may be configured that the image formation is not performed if the sheet S set through the display screen 70 and the result by the double feeding sensor 100 are different. Furthermore, as in the case of the process procedure upon the detection of the double feeding of the plain paper, it may be configured that the image forming operation is stopped and notify the user to prompt the jam clearance.

For the seventh sheet, the detection result by the double feeding sensor 100 becomes the multiple layer again, which corresponds to the setting through the display screen 70, so that the control portion 8 stops the sheet S at the registration roller pair 41 again and automatically switches to the second process speed of higher speed PS2. By this, it becomes possible to improve productivity for the short envelopes.

As described above, according to the image forming apparatus 1 in the present Embodiment, for the second sheet of which the sheet length is shorter than Lx (mm), if the layer information acquired through the display screen 70 and the layer information detected by the double feeding sensor 100 are the single layer type, the control portion 8 executes the first mode. The first mode is the mode, in the case in which a sheet is fed from the feeding unit 3 at the feeding speed Sf, in which the conveyance speed is set to the first process speed PS1 and the sheet is conveyed. Therefore, when the control portion 8 executes the stop process for the fixing roller 61, the second sheet stops at the position at which the second sheet can be detected by the pre-fixing sensor 63, so that even if a sheet jam occurs by the sheet winding around the fixing roller 61, that winding sheet can be detected.

In addition, in the present Embodiment, by comparing the information set through the display screen 70 and the detection result from the double feeding sensor 100, the process speed is set. In particular, since the second process speed PS2 is applied to the envelope even for those of short length, it becomes possible to maintain productivity high while suppressing the occurrence of the jam, and contribute to high productivity and support for a variety of media in a commercial printing business.

### OTHER EMBODIMENTS

Incidentally, in the Embodiment described above, the case in which the ultrasonic wave type is adopted as the double feeding sensor 100 is described, however, it is not limited thereto. The double feeding sensor 200, which detects the thickness of the sheet, shown in part (b) of FIG. 3, may be adopted. In this case, the operating portion 7 becomes a portion through which thickness information whether a fed sheet has a first thickness or a second thickness thicker than the first thickness is input. In addition, the double feeding sensor 200 is an example of a thickness detecting sensor, and detects thickness information whether the thickness of the conveyed sheet S is the first thickness or the second thickness. Furthermore, for the second sheet (plain paper) of which the sheet length is shorter than Lx (mm), if the thickness information acquired through the display screen 70 is the first thickness and the thickness information detected by the double feeding sensor 200 is the first thickness, the control portion 8 executes a third mode. The third mode is a mode, in a case in which a sheet is fed from the feeding unit 3 at the feeding speed Sf, in which the conveyance speed is set to the first process speed PS1 and the sheet is conveyed. On the other hand, for the second sheet (envelope) of which the sheet length is shorter than Lx (mm), if the thickness information acquired through the display screen 70 is the second thickness and the thickness information detected by the double feeding sensor 200 is the second thickness, the control portion 8 executes a fourth mode. The first mode is a mode, in a case in which a sheet is fed from the feeding unit 3 at the feeding speed Sf, in which the conveyance speed is set to the second process speed PS2 and the sheet is conveyed. The control portion 8 is capable of executing the third mode and the fourth mode for the second sheet of which the sheet length is shorter than Lx (mm).

In addition, in each Embodiment described above, the case in which if the sheet is fed at the feeding speed Sf from the feeding unit 3, the feeding speed Sf is changed to the second process speed PS2 and the first process speed PS1 is described, however, it is not limited thereto. For example, it may be configured to, depending on the length of the sheet and/or the type of the sheet, convey the sheet from the feeding unit 3 at the second process speed PS2 and the first process speed PS1.

According to the present disclosure, it becomes possible to detect the sheet which causes the sheet jam by winding around the fixing rotatable member.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-160021 filed on Sep. 17, 2024, which is hereby incorporated by reference herein in its entirety.

What is claimed is:

1. An image forming apparatus comprising:
a transfer portion configured to transfer an image to a sheet;
a fixing portion including a fixing rotatable member configured to fix the image by heating the sheet on which the image is transferred by the transfer portion and to convey the sheet; and
a control portion configured to control a conveyance speed of the fixing rotatable member,
wherein in a case in which a first plain paper of which a sheet length in a sheet conveyance direction is equal to or more than a predetermined length is conveyed, the fixing rotatable member conveys the first plain paper at a first speed,
wherein in a case in which a second plain paper of which the sheet length in the sheet conveyance direction is less than the predetermined length is conveyed, the fixing rotatable member conveys the second plain paper at a second speed less than the first speed, and
wherein in a case in which a second envelope of which the sheet length in the sheet conveyance direction is less than the predetermined length is conveyed, the fixing rotatable member conveys the second envelope at the first speed.

2. The image forming apparatus according to claim 1, further comprising:
a first detecting portion provided upstream of the fixing rotatable member in the sheet conveyance direction and configured to detect the sheet to be conveyed by the fixing rotatable member; and
a second detecting portion provided downstream of the fixing rotatable member in the sheet conveyance direction and configured to detect the sheet conveyed by the fixing rotatable member,
wherein the control portion stops the fixing rotatable member in a case in which the sheet conveyed by the fixing rotatable member is not detected by the second detecting portion after a lapse of a setting time.

3. The image forming apparatus according to claim 2, wherein the control portion stops the fixing rotatable member in a state in which a trailing end of the sheet is detected by the first detecting portion in the case in which the sheet conveyed by the fixing rotatable member is not detected by the second detecting portion after the lapse of the setting time.

4. The image forming apparatus according to claim 1, wherein the first plain paper is conveyed at the first speed as a conveyance speed in the transfer portion and the fixing rotatable member,
wherein the second plain paper is conveyed at the second speed as the conveyance speed in the transfer portion and the fixing rotatable member, and
wherein the second envelope is conveyed at the first speed as the conveyance speed in the transfer portion and the fixing rotatable member.

5. The image forming apparatus according to claim 1, wherein in a case in which a first envelope of which the sheet length in the sheet conveyance direction is equal to or more than the predetermined length is conveyed, the fixing rotatable member conveys the first envelope at the first speed.

6. The image forming apparatus according to claim 1, further comprising an input portion configured to input information on a sheet to be used in printing by a user; and
a layer detecting sensor disposed upstream of the transfer portion in the sheet conveyance direction and configured to detect whether the sheet which is conveyed is a single layer or a multiple layer
wherein in a case in which a type of the sheet inputted from the input portion is an envelope and a detecting result of the sheet detected by the layer detecting sensor is the single layer, the control portion causes the fixing rotatable member to convey the sheet at the second speed.

7. The image forming apparatus according to claim 6, wherein in a case in which the type of the sheet inputted from the input portion is a plain paper and the detecting result of the sheet detected by the layer detecting sensor is the multiple layer, the control portion causes the fixing rotatable member to stop the conveyance of the sheet.

8. The image forming apparatus according to claim 6, wherein the layer detecting sensor is an ultrasonic sensor including a transmitting portion configured to transmit an ultrasonic wave and a receiving portion configured to receive the ultrasonic wave transmitted from the transmitting portion.

9. The image forming apparatus according to claim 1, wherein the predetermined length is 182 mm.
